(19) United States
(12) Patent Application Publication
(10) Pub. No.: US 2023/0325919 A1
(43) Pub. Date: Oct. 12, 2023

(54) STOCK TRADING SYSTEM ON BASIS OF ACTIVITY VALUATION OF EXTERNAL ONLINE ACCOUNT

(71) Applicant: Hak Soo KIM, Asan-si (KR)

(72) Inventor: Hak Soo KIM, Asan-si (KR)

(21) Appl. No.: 18/025,578

(22) PCT Filed: Sep. 14, 2021
(86) PCT No.: PCT/KR2021/012474

§ 371 Date: Mar. 9, 2023

(30) Foreign Application Priority Data
Sep. 14, 2020 (KR) 10-2020-0117671

(51) Int. Cl. G06Q 40/04; G06Q 30/0273; G06Q 50/00; G06Q 20/38; G06Q 40/02

(52) U.S. Cl. CPC G06Q 40/04; G06Q 30/0273; G06Q 40/02; G06Q 20/381; G06Q 50/01

(57) ABSTRACT

Provided are a stock trading system based on activity valuation of an external online account, and a stock trading method, of the stock trading system, wherein an online account on another site including at least one selected from a group of a blog account, an SNS account, a web cafe account, and a multimedia streaming account is regarded as a business account and stock of the business account is issued, and whether to list the stock on the system's own stock exchange is determined through valuation of responses, such as the number of views, comments, like/dislike marks, heart marks, thumbs-up/down marks, and recommendation/non-recommendation marks, from users of personal accounts to the business account and social influence of the business account, wherein the stock exchange enables mined virtual money to be used as a means of currency to reward activities of the business account and the personal accounts.

### TECHNICAL FIELD

The present disclosure relates to a stock trading system based on activity valuation of an external online account. More particularly, the present disclosure relates to a stock trading system based on activity valuation of an external online account, wherein the system is capable of providing a new concept of a cyber stock market and is configured to register external online accounts, which include blog accounts on several external web portals, SNS accounts on Twitter, Facebook, Instagram, etc., web cafe accounts, multimedia streaming accounts, etc., as business accounts to issue stocks of the business accounts, and determine whether to list the stocks on the system's own stock exchange through valuation of responses, such as comments, likes, etc., from users of personal accounts to the business accounts and social influences of the business accounts, wherein the stock exchange enables mined virtual money to be used as a means of currency to reward activities of the business accounts and the personal accounts.

### BACKGROUND ART

As the distribution rate of smartphones and smartpads increases, the Internet ecosystem has been rapidly changed because information sharing and communication using conventional SNSs (blog, minihompy, etc.), short message-typed SNSs (Facebook, Twitter, etc.), and mobile SNSs (KakaoTalk, TikTok, etc.) enabling transmission of instant messages have been actively encouraged. The SNSs are widely used more and more as user-friendly services are provided with combinations of platforms, such as web services, mobile applications, etc., through open APIs.

Such SNSs show greater effects than conventional online marketing and advertising because of characteristics such as the ripple effect of real-time services and information. Accordingly, a system for evaluating monetary values of popular SNS accounts and generating profits by using the values is actively being researched and developed.

According to these circumstances, the present disclosure is intended to propose a technology for a new concept of a cyber stock market system, wherein the system is configured to issue stocks of business accounts, such as blog, cafe, and SNS accounts, and determine whether to list the stocks on the system's own stock exchange through valuation of responses, such as comments, likes, etc., from users of personal accounts to the business accounts and social influences of the business accounts, wherein the stock exchange enables mined virtual money to be used as a means of currency to reward activities of the business accounts and the personal accounts.

Next, the related art in the field to which the technology of the present disclosure belongs will be briefly described, and then distinguishing technical features of the present disclosure to be achieved will be described.

First, Korean Patent Application Publication No. 2001-0091620 (published 23 Oct. 2001) relates to a method of promoting sales through evaluation of value of activities in Internet sites and stock allocation. More specifically, the method includes: accessing a server in which an Internet environment is constructed, by a user of an Internet site through a terminal; inputting an ID of the buyer to the server to receive approval; selecting activities on the Internet site the user wants in the server; performing, by the user, the activities or electronic commerce by using the Internet site; evaluating all the activities on the Internet site; assigning units based on the evaluation to the user or a user group or an internal management; informing the user or the outside of details of value per assigned unit, especially, statistical details; announcing an enterprise to a stock market on the basis of value of the enterprise obtained through the activities; estimating a stock price; allocating the stock price to the current units; determining a user allotment ratio to the total stock volume; allotting the determined allotment to the user group; and restoring the value allotted in unit to shares.

Korean Patent Application Publication No. 2001-0091620 relates to a technology for evaluating online activity value and providing stock as rewards, so there are some similarities in that rewards are allotted according to online activity value. However, there is a difference because the document in the related art relates to allocation of the stock of an Internet site according to the degree of contribution of activities on the Internet site while the present disclosure relates to a system for issuing stock of one's account and determining the value of stock according to the value of one's account.

In addition, Korean Patent Application Publication No. 2013-0062428 (published 13 Jun. 2013) relates to a system for measuring social capital value of a social networking service account, and more specifically, a system for measuring social capital value of a social networking service (SNS) account, wherein in order to evaluate the social capital value of the SNS account, the SNS account is allowed to be traded on a virtual stock market and users evaluate the value of the SNS account.

Since Korean Patent Application Publication No. 2013-0062428 relates to a system that enables an online account to be traded on a stock market, there are some similarities with the present disclosure. However, there is a difference because the present disclosure relates to a system that actually issues stock of an online account and is capable of forming an actual stock market that enables stock trading with virtual money mined in the system of the present disclosure while the document in the related art relates to merely a technology in which stock of an SNS account is listed on a virtual stock market and trading between users raises and lowers the market price of the stock of the SNS account and the social capital value of the SNS account is thus evaluated.

In addition, Korean Patent No. 10-1849690 (published 30 May 2018) relates to a public-figure stock operation system based on artificial intelligence, and more specifically, a stock operation system in which information on public figure stock issued on the basis of information on a public figure is provided, a stock fluctuation value determined on the basis of activity information of the public figure is provided, a service for selling or buying the public figure stock is provided, the activity information of the public figure of which the stock is issued is collected, the fluctuation value of the public figure stock is calculated on the basis of the collected activity information of the public figure so as to determine and publish a stock value.

There are some similarities because Korean Patent No. 10-1849690 relates to a system that provides public figure stock information issued on the basis of public figure information and services trade of stock and the present disclosure relates to a system that issues stock of an online account and services trade of the stock. However, there is a difference because according to the document in the related art, activity information of a public figure determines the value of the public figure while according to the present disclosure, responses, such as comments, from general users of personal accounts determine the value of an online account that is a business account. In addition, according to the present disclosure, virtual money, which is a means of currency that can be used as cash in the system, is provided to reward activities of business accounts and personal accounts so that profits can be generated, and the business accounts are provided with cash on condition that advertisements are published, and the personal accounts are provided with virtual money for dividends on stocks of the business accounts, whereby all personal account users and business account users use the system actively. However, the document in the related art does not disclose the technology for such a new stock system structure.

### DISCLOSURE

### Technical Problem

The present disclosure is invented in response to the demand for new profit generation based on the value of an online account and a market model therefor, and is directed to providing a stock trading system based on activity valuation of an external online account and a stock trading method of the stock trading system that issues, on the basis of the value of the online account on another site, stock of the account and enables the stock to be traded, wherein the online account includes at least one selected from a group of a blog account, an SNS account, a web cafe account, and a multimedia streaming account.

### Technical Solution

According to an embodiment of the present disclosure, there is provided a stock trading system based on activity valuation of an external online account, the system including: a business account management part configured to provide and manage an interface for joining the system with the online account on another site as a business account and for making a request for issuance of stock of the business account that has joined the system, and configured to collect and manage business account activity information including post upload information of the business account and post response information, wherein the online account includes at least one selected from a group of a blog account, an SNS account, a web cafe account, and a multimedia streaming account, and the post response information includes the number of views, a comment, a like/dislike mark, a heart mark, a thumbs-up/down mark, and a recommendation/non-recommendation mark with respect to an uploaded post; a personal account management part configured to provide and manage an interface for opening an personal account through membership registration, and configured to provide and manage an interface for agreeing to collect personal information and personal activity information, and configured to selectively collect and manage the agreed personal information with respect to the online account on the site and the agreed personal activity information with respect to the post uploaded to the business account, and configured to provide and manage an interface for performing trade of the issued stock of the business account, wherein the personal information is capable of accessing the business account and reading the post uploaded to the business account after membership registration, with respect to the online account on the site including at least one selected from the group of the blog account, the SNS account, the web cafe account, and the multimedia streaming account, and the personal activity information includes a comment input, a like/dislike input, a heart input, a thumbs-up/down input, and a recommendation/non-recommendation input with respect to the post uploaded to the business account; a stock exchange management part configured to provide stock information including a real-time stock price and a trading volume of the issued stock of the business account, and configured to provide and manage an interface for enabling the personal account to access the interface and trade the stock; a virtual money mining part configured to score the business account activity information of the business account and the personal activity information of the personal account according to predetermined criteria, and provide the business account and the personal account with virtual money corresponding to scores; a business account stock management part configured to issue the stock in response to the request for stock issuance received from the business account, and manage listing or delisting the issued stock of the business account on or from a stock exchange by using the post response information with respect to the post uploaded to the business account and social influence of the business account as evaluation bases; an advertisement and dividend management part configured to manage paying a predetermined advertising cost to the business account and to the site to which the online account of the business account belongs, on condition that an order for an advertisement is received and the advertisement is published to the business account, and manage paying a predetermined dividend to the personal account that owns the stock of the business account, according to advertising revenue of the business account; and a database configured to store and manage data of the business account management part, the personal account management part, the stock exchange management part, the virtual money mining part, the business account stock management part, and the advertisement and dividend management part.

In addition, according to the embodiment of the present disclosure, in the stock trading system based on activity valuation of the external online account, the personal account management part may be configured to provide an interface for accessing the site when an icon of the site is clicked, and for being automatically linked to a personal activity log page on the site.

In addition, according to the embodiment of the present disclosure, in the stock trading system based on activity valuation of the external online account, in selectively collecting and managing the agreed personal information with respect to the online account on the site and the agreed personal activity information, the personal account management part may be configured to selectively collect required information by using an open application program interface (open API) or a data collection technology including crawling.

In addition, according to the embodiment of the present disclosure, in the stock trading system based on activity valuation of the external online account, the advertisement and dividend management part may be configured to analyze the post response information with respect to the post uploaded to the business account and the personal information of the personal account that has accessed the business account, and extract business account visitor information including a sex, an age, and a field of interest of a user of a mainly visiting personal account for each business account, and publish the advertisement according to the extracted business account visitor information.

In addition, according to the embodiment of the present disclosure, the stock trading system based on activity valuation of the external online account may include a virtual money exchange part configured to provide a virtual money exchange service in which a user of the business account or the personal account is capable of exchanging the virtual money into cash and depositing the cash into a registered bank account of the user, wherein the virtual money exchange service may be provided through an interface within the business account, the personal account, or the stock exchange, or may provide a separate interface for the virtual money exchange service in the virtual money exchange part.

In addition, according to the embodiment of the present disclosure, in the stock trading system based on activity valuation of the external online account, in the stock exchange, stock trading time may not be limited and only the virtual money provided by the virtual money mining part may be available as currency for stock trading.

In addition, according to the embodiment of the present disclosure, the stock trading system based on activity valuation of the external online account may further include a user service provision part configured to provide at least one of online shopping mall, game, and multimedia services in which the virtual money provided by the virtual money mining part is available as currency.

In addition, according to the embodiment of the present disclosure, in the stock trading system based on activity valuation of the external online account, the virtual money exchange part may be configured to provide a virtual money bank service, wherein the virtual money bank service may include a virtual money-related financial service including loan of the virtual money, and a service for issuing a credit card available within the stock trading system based on activity valuation of the external online account.

In addition, according to another embodiment of the present disclosure, there is provided a stock trading method of a stock trading system based on activity valuation of an external online account, the stock trading method including: joining the system with the online account on another site including at least one selected from a group of a blog account, an SNS account, a web cafe account, and a multimedia streaming account, as a business account; collecting and managing business account activity information that includes post upload information of the business account and post response information including the number of views, a comment, a like/dislike mark, a heart mark, a thumbs-up/down mark, and a recommendation/non-recommendation mark with respect to an uploaded post; opening a personal account on the system through membership registration, and obtaining agreement to collect personal information and personal activity information, wherein the personal information is capable of accessing the business account and reading the post uploaded to the business account after membership registration, with respect to the online account on the site including at least one selected from the group of the blog account, the SNS account, the web cafe account, and the multimedia streaming account, and the personal activity information includes a comment input, a like/dislike input, a heart input, a thumbs-up/down input, and a recommendation/non-recommendation input with respect to the post uploaded to the business account; selectively collecting and managing the agreed personal information with respect to the online account on the site and the agreed personal activity information with respect to the post uploaded to the business account; scoring the business account activity information of the business account and the personal activity information of the personal account according to predetermined criteria, and providing the business account and the personal account with virtual money corresponding to scores; issuing stock of the business account on the basis of the virtual money that the business account owns when a request for stock issuance is received from the business account, and listing the issued stock of the business account on a stock exchange within the system by using the business account activity information of the business account and social influence of the business account as evaluation bases so that the personal account is capable of trading the stock; and managing paying a predetermined advertising cost to the business account and to the site to which the online account of the business account belongs, on condition that an order for an advertisement is received and the advertisement is published to the business account, and managing paying a predetermined dividend to the personal account that owns the stock of the business account, according to advertising revenue of the business account, in an advertisement and dividend management step.

In addition, according to the embodiment of the present disclosure, the stock trading method of the stock trading system based on activity valuation of the external online account may further include providing an interface for accessing the site when an icon of the site is clicked after a site within the system is accessed through the personal account, and for being automatically linked to a personal activity log page on the site of which the icon is clicked.

In addition, according to the embodiment of the present disclosure, in the stock trading method of the stock trading system based on activity valuation of the external online account, in selectively collecting and managing the agreed personal information with respect to the online account on the site and the agreed personal activity information, required information may be selectively collected by using an open application program interface (open API) or a data collection technology including crawling.

In addition, according to the embodiment of the present disclosure, in the stock trading method of the stock trading system based on activity valuation of the external online account, in the advertisement and dividend management step, the post response information with respect to the post uploaded to the business account and the personal information of the personal account that has accessed the business account may be analyzed, and business account visitor information including a sex, an age, and a field of interest of a user of a mainly visiting personal account for each business account may be extracted, and the advertisement may be published according to the extracted business account visitor information.

In addition, according to the embodiment of the present disclosure, the stock trading method of the stock trading system based on activity valuation of the external online account may further include providing a virtual money exchange service in which a user of the business account or the personal account is capable of exchanging the virtual money into cash and depositing the cash into a registered bank account of the user.

In addition, according to the embodiment of the present disclosure, in the stock trading method of the stock trading system based on activity valuation of the external online account, in trading the issued stock of the business account by the personal account, a stock trading time may not be limited and only the virtual money may be available as currency for stock trading.

In addition, according to the embodiment of the present disclosure, the stock trading method of the stock trading system based on activity valuation of the external online account may further include providing at least one of online shopping mall, game, and multimedia services in which the virtual money is available as currency.

In addition, according to the embodiment of the present disclosure, the stock trading method of the stock trading system based on activity valuation of the external online account may further include providing a virtual money bank service, wherein the virtual money bank service may include a virtual money-related financial service including loan of the virtual money, and a service for issuing a credit card available within the stock trading system based on activity valuation of the external online account.

### Advantageous Effects

According to the present disclosure, an online account on another site including at least one selected from a group of a blog account, an SNS account, a web cafe account, and a multimedia streaming account is regarded as a business account and stock of the business account is issued, and the issued stock of the business account is listed on a stock exchange of the system by using a post response, such as a comment, a like mark, etc., to a post uploaded to the business account and social influence of the business account as evaluation bases, and the business account and a personal account are provided with virtual money corresponding to a post uploading activity of the business account and activities, such as a comment, a like mark, etc., of the personal account, and the virtual money is serviced to be used as stock trading currency in the stock exchange, thereby providing a new paradigm stock market system.

In addition, according to the present disclosure, in a structure for the business account and the personal account to generate profit, virtual money is mined as reward for business account activities and personal account activities, and advertising charge is received from an advertiser on condition that an advertisement is published to the business account, and the business account is paid a predetermined advertising cost as the advertisement is published to the business account, and the business account uses a method of paying a personal account that owns the stock of the business account a predetermined dividend according to advertising revenue, whereby activities of business accounts and personal accounts can generate profit and business account users and personal account users can be motivated to do activities within the system.

### DESCRIPTION OF DRAWINGS

FIG. 1 is a block diagram illustrating a stock trading system based on activity valuation of an external online account according to an embodiment of the present disclosure.

FIG. 2 is a diagram illustrating an example of the flow of virtual money and stock in a stock trading system based on activity valuation of an external online account according to an embodiment of the present disclosure.

FIG. 3 is a conceptual diagram illustrating a profit structure in a stock trading system based on activity valuation of an external online account according to an embodiment of the present disclosure.

FIG. 4 is a flowchart illustrating a stock trading method based on activity valuation of an online account according to an embodiment of the present disclosure.

### BEST MODE

Hereinafter, exemplary embodiments of a stock trading system based on activity valuation of an external online account according to the present disclosure will be described in detail with reference to the accompanying drawings such that the present disclosure can be easily embodied by those skilled in the art to which the present disclosure pertains.

In each drawing of the present disclosure, the sizes and names of the blocks shown in the drawing are conceptually expressed for clarity of the present disclosure. In addition, known configurations are omitted to reveal the characteristic configuration of the present disclosure, so the present disclosure is not limited to the drawings.

In describing the principles of the exemplary embodiments of the present disclosure in detail, if it is decided that a detailed description of the known function or configuration related to the present disclosure makes the subject matter of the present disclosure unclear, the detailed description will be omitted.

In addition, configurations described in exemplary embodiments and the accompanying drawings of the specification do not represent all of the technical spirits of the present disclosure, but are merely most preferable embodiments. Therefore, it should be understood that various equivalents and modifications thereof could be made at the time of filing this application.

A stock trading system based on activity valuation of an external online account according to the present disclosure relates to a new stock trading system in which an online account on another site is used as a business account to join the system of the present disclosure, and stock of the business account is issued, and a personal account that has joined the system of the present disclosure accesses the online account on the site corresponding to the business account and is linked to the online account on the site to read a post uploaded to the online account or make a comment to the post, and virtual money is provided as rewards for activities of various accounts, such as the business account and the personal account, and the issued stock of the business account is traded with the virtual money as a means of currency.

For reference, in describing the present disclosure, a business account is in the form of various online accounts, such as blog, cafe, SNS accounts, etc. The business account is a subject that provides and manages online information on various objects, such as public figures, entertainers, politicians, particular goods, etc., and also provides other types of online information to provide and manage promotion and information of provided objects effectively, and is a subject that enables personal account holders to determine information effectively and participate.

The business account is basically based on an online account (for example, Twitter, Facebook, YouTube, etc.) outside the system of the present disclosure, but may be based on a new type of an online account provided within the system of the present disclosure.

In addition, when activities (uploading of posts, comments on uploaded posts, and the like) of the business account increase, advertising cost may be paid on condition that advertisements are published. When stock of the business account is listed, the value of the business account increases. Issued stock can be bought and sold by personal account holders, and is a subject that shares the increased value of the business account between the stockholders in various ways.

In addition, a personal account belongs to a natural person who has joined the system of the present disclosure, and owns only one account after user authentication, and does various activities, such as comments, likes, subscriptions, etc., to a post uploaded to a business account, and receives virtual money from the system of the present disclosure as reward, and sells and buys the stock of the business account with the virtual money, and exchanges the virtual money into cash from a virtual money exchange within the system.

Hereinafter, a stock trading system based on activity valuation of an external online account according to the present disclosure will be described in detail with reference to the accompanying drawings.

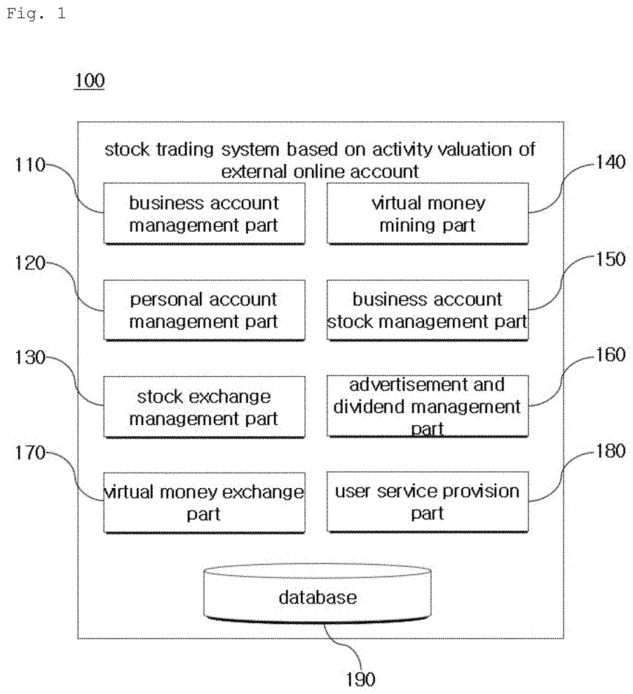

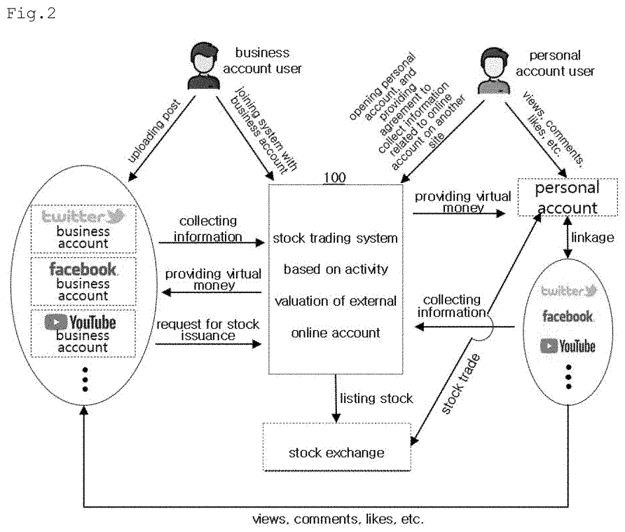

FIG. 1 is a block diagram illustrating a stock trading system 100 based on activity valuation of an external online account according to an embodiment of the present disclosure. FIG. 2 is a diagram illustrating an example of the flow of virtual money and stock in a stock trading system 100 based on activity valuation of an external online account according to an embodiment of the present disclosure.

As shown in the figures, the stock trading system 100 based on activity valuation of an external online account according to the present disclosure includes a business account management part 110, a personal account management part 120, a stock exchange management part 130, a virtual money mining part 140, a business account stock management part 150, an advertisement and dividend management part 160, and a database 190.

More specifically, the business account management part 110 provides and manages an interface for joining the system with an online account on another site (for example, Twitter, Facebook, Instagram, Tistory, web portal blog, web portal cafe, AfreecaTV, Twitch, YouTube, etc.) including at least one selected from a group of a blog account, an SNS account, a web cafe account, and a multimedia streaming account, as a business account, and for making a request for issuance of stock of the business account that has joined the system.

In addition, the business account management part 110 collects and manages business account activity information including post upload information of the business account and post response information that includes the number of views, a comment, a like/dislike mark, a heart mark, a thumbs-up/down mark, and a recommendation/non-recommendation mark with respect to an uploaded post.

For reference, the posts include text, pictures, photos, sounds, music, videos, and complex multimedia.

To this end, the business account management part 110 provides and manages an interface that performs at least one selected from a group of membership registration, account opening, post uploading, and stock issuance requesting for the business account, in association with an existing external system that services the online account on the site including at least one selected from the group of the blog account, the SNS account, the web cafe account, and the multimedia streaming account.

According to the present disclosure, in the stock trading system 100 based on activity valuation of an external online account, a user may register his or her own business brand including a name, a group name, and a team name, as a business account name.

In addition, the personal account management part 120 provides and manages an interface for opening a personal account through membership registration, and provides and manages an interface for agreeing to collect: personal information capable of accessing the business account and reading a post uploaded to the business account after membership registration, with respect to the online account on the site including at least one selected from the group of the blog account, the SNS account, the web cafe account, and the multimedia streaming account; and personal activity information including a comment input, a like/dislike input, a heart input, a thumbs-up/down input, and a recommendation/non-recommendation input with respect to a post uploaded to the business account.

In addition, the personal account management part 120 selectively collects and manages the agreed personal information with respect to the online account on the site and the agreed personal activity information with respect to a post uploaded to the business account.

In selectively collecting and managing the agreed personal information with respect to the online account on the site and the agreed personal activity information, the personal account management part 120 selectively collects required information by using an open application program interface (open API) or a data collection technology including crawling.

In addition, the personal account management part 120 provides and manages an interface for performing trade of the issued stock of the business account.

In addition, the personal account management part 120 provides an interface for providing an icon to access another site within the interface when the system of the present disclosure is accessed with a personal account, and for accessing the site when the icon of the site is clicked, and for being automatically linked to a personal activity log page on the site.

In addition, the stock exchange management part 130 provides stock information including a real-time stock price and a trading volume of the issued stock of the business account, and provides and manages an interface for a stock exchange to enable the personal account to access the interface and trade the stock.

In addition, according to the present disclosure, in the stock exchange of the stock trading system 100 based on activity valuation of an external online account, a stock trading time is not limited and only the virtual money mined by the virtual money mining part 140 is available as currency for stock trading. Alternatively, with a link to existing virtual money, such as Bitcoin, Ethereum, Ripple, etc., it may be possible to trade stock only with the linked virtual money.

The business account, personal account, and stock exchange may be provided through interfaces that the same Internet site provides, or may be provided through interfaces that at least two Internet sites provide.

In addition, the virtual money mining part 140 scores the business account activity information of the business account and the personal activity information of the personal account according to predetermined criteria, and provides the business account and the personal account with virtual money corresponding to scores.

The business account receives (mined) virtual money as a reward for business account activities in this way, and makes a request for stock issuance on the basis of the received virtual money.

In addition, the personal account is paid virtual money according to personal account activities (personal activities) including a comment input, a like/dislike input, a heart input, a thumbs-up/down input, and a recommendation/non-recommendation input, and is also paid virtual money in proportion to favorability including like marks, heart marks, thumbs-ups, and recommendations that other personal accounts input with respect to the comment that the personal account inputs.

In addition, the business account stock management part 150 issues stock in response to the request for stock issuance received from the business account, and manages listing or delisting the issued stock of the business account on or from the stock exchange by using post response information with respect to a post uploaded to the business account and social influence of the business account as evaluation bases.
The influence of the business account is affected by online/offline activities of the user of the business account. Herein, the activities include public activities, private activities, and related issues.

In addition, the advertisement and dividend management part 160 manages paying a predetermined advertising cost to a business account and another site to which an online account of the business account belongs, on condition that an order for an advertisement is received and the advertisement is published to the business account, and also manages paying a predetermined dividend to a personal account that owns the stock of the business account, according to advertising revenue of the business account.

In addition, the advertisement and dividend management part 160 analyzes post response information with respect to a post uploaded to a business account and personal information of a personal account that has accessed the business account, and extracts business account visitor information including the sex, age, and field of interest of a user of a mainly visiting personal account for each business account, and publishes an advertisement according to the extracted business account visitor information.

In addition, a commenter (personal account) that has obtained a predetermined degree of favorability or greater accedes to a ‘super commenter’, and a personal account that has acceded to a super commenter in this way may be paid a predetermined advertising cost or additional virtual money.

In addition, according to the present disclosure, in the stock trading system 100 based on activity valuation of an external online account, it is preferable that advertising cost paid to a business account and a personal account is in cash currency and a dividend paid to a personal account is virtual money.

In addition, the database 190 stores and manages data of the business account management part 110, the personal account management part 120, the stock exchange management part 130, the virtual money mining part 140, the business account stock management part 150, and the advertisement and dividend management part 160.

In addition, according to the present disclosure, the stock trading system 100 based on activity valuation of an external online account may include a virtual money exchange part 170 that provides a virtual money exchange service in which the user of the business account or the personal account exchanges the virtual money into cash and deposits the cash into a registered bank account of the user.

The virtual money exchange service provides an interface within the business account, the personal account, or a stock exchange, or provides a separate interface for the virtual money exchange service in the virtual money exchange part 170.

In addition, the virtual money exchange part 170 may provide a virtual money bank service within the system of the present disclosure.

The virtual money bank service provides a virtual money-related financial service including deposit/withdrawal of virtual money, loan of virtual money, etc., and may also issue a credit card commonly used within the system of the present disclosure. The credit card may be used to purchase charged services, goods, and stocks within the system of the present disclosure. All trades within the system of the present disclosure are made with virtual money, so a credit card bill is also paid with virtual money.

In addition, according to the present disclosure, the stock trading system 100 based on activity valuation of an external online account may further include a user service provision part 180 that provides at least one of online shopping mall, game, and multimedia services in which virtual money mined by the virtual money mining part 140 is used as currency.

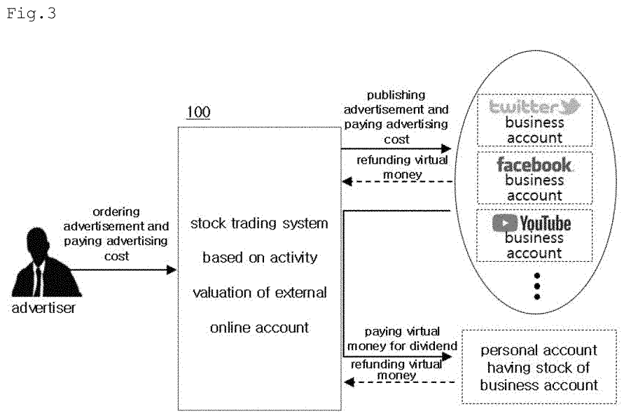

FIG. 3 is a conceptual diagram illustrating a profit structure in a stock trading system 100 based on activity valuation of an external online account according to an embodiment of the present disclosure.

For reference, the configuration of the stock trading system 100, which includes the business account management part 110, the personal account management part 120, the stock exchange management part 130, the virtual money mining part 140, the business account stock management part 150, the advertisement and dividend management part 160, the virtual money exchange part 170, and the user service provision part 180, based on activity valuation of the external online account according to the present disclosure is merely presented as an illustrative independent configuration to describe the structure and provided functions of the system according to the present disclosure. The key technical features of the system according to the present disclosure are in the functions performed by each of the above-described elements. In practice, the key technical features may be realized through elements that are fewer or more than those of the configuration and have the functions of each of the above-described elements, and a single server or multiple servers may provide the functions of the configuration.

As shown in FIG. 3, regarding the profit structure of the stock trading system 100 based on activity valuation of an external online account according to the present disclosure, first, the system of the present disclosure generates profit by obtaining advertising cost on condition that an order for an advertisement is received from an advertiser through the advertisement and dividend management part 160.

In addition, in cooperation with another site to which an online account of the business account belongs, the advertisement for the order is received is exposed to a user of a personal account through an interface within the online account on the site, and in return, the site and the business account are paid a predetermined advertising cost.

As described above, the advertising cost paid to the business account is paid differentially according to a valuation score of the business account which involves business account activities of the business account and personal account activities (personal activities) of personal account users with respect to the business account. Alternatively, the advertising cost paid to the business account is paid in proportion to market capitalization of the issued stock of the business account. Accordingly, users of business accounts may be encouraged to do business account activities actively.

In addition, a personal account that owns the issued stock of the business account may be paid a dividend in proportion to advertising cost that the business account for the owned stock has obtained.

The dividend may be accumulated for a predetermined period of time and paid, or may be paid each time an advertisement is published to the business account.

In addition, as described above, in addition to the profit on the advertisement, for the business account, virtual money is mined through post uploading and post responses including the number of views, a comment, a like/dislike mark, a heart mark, a thumbs-up/down mark, and a recommendation/non-recommendation mark, and for the personal account, virtual money is mined through a comment input, a like/dislike input, a heart input, a thumbs-up/down input, and a recommendation/non-recommendation input with respect to a post uploaded to the business account. Accordingly, the users of the business account and the personal account may generate profit.

The virtual money mined in this way is used in the same manner as real money within the system according to the present disclosure, so that the users of the business account and the personal account can be encouraged to do account activities.

That is, according to the present disclosure, in the stock trading system 100 based on activity valuation of the external online account, the main source of income for the business account is virtual money mining and advertising cost caused by account activities, such as post uploading, etc. The main source of income for the personal account is virtual money mining caused by account activities, which include input of favorability including a comment input, a like mark, and a heart mark, and a dividend paid when the stock is owned.

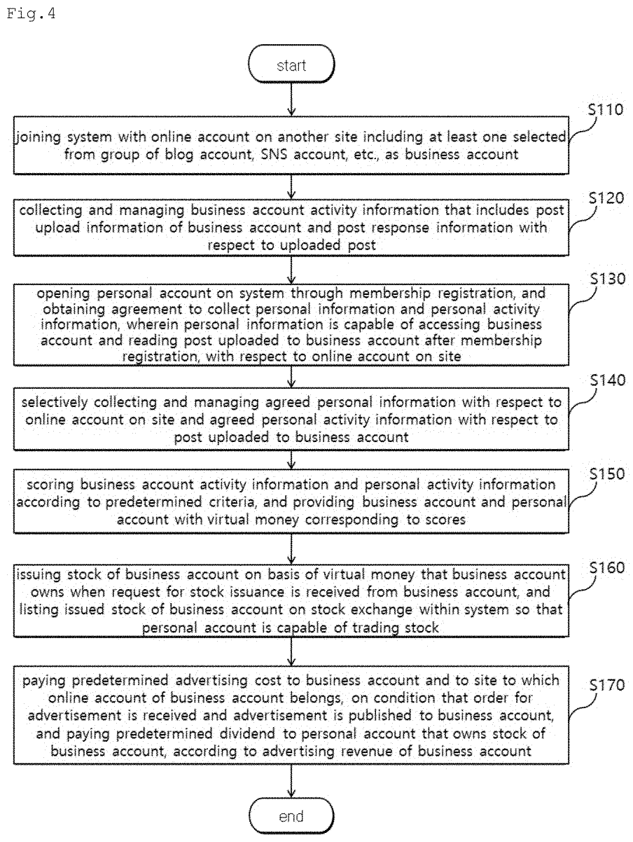

FIG. 4 is a flowchart illustrating a stock trading method based on activity valuation of an external online account according to an embodiment of the present disclosure.

For reference, FIG. 4 is an illustrative flowchart of a stock trading method based on activity valuation of an external online account according to the present disclosure. It is noted that the stock trading method based on activity valuation of an online account according to the present disclosure is not necessarily performed in the order shown in the flowchart of FIG. 4 and each step may be performed independently or in association with another step.

As shown in FIG. 4, the stock trading method based on activity valuation of an external online account according to the present disclosure includes: joining the system with the online account on another site including at least one selected from a group of a blog account, an SNS account, a web cafe account, and a multimedia streaming account, as a business account in step S110;
collecting and managing business account activity information that includes post upload information of the business account and post response information including the number of views, a comment, a like/dislike mark, a heart mark, a thumbs-up/down mark, and a recommendation/non-recommendation mark with respect to an uploaded post, in step S120;
opening a personal account on the system through membership registration, and obtaining agreement to collect personal information and personal activity information, wherein the personal information is capable of accessing the business account and reading the post uploaded to the business account after membership registration, with respect to the online account on the site including at least one selected from the group of the blog account, the SNS account, the web cafe account, and the multimedia streaming account, and the personal activity information includes a comment input, a like/dislike input, a heart input, a thumbs-up/down input, and a recommendation/non-recommendation input with respect to the post uploaded to the business account, in step S130;
selectively collecting and managing the agreed personal information with respect to the online account on the site and the agreed personal activity information with respect to the post uploaded to the business account, in step S140;
scoring the business account activity information of the business account and the personal activity information of the personal account according to predetermined criteria, and providing the business account and the personal account with virtual money corresponding to scores, in step S150;
issuing stock of the business account on the basis of the virtual money that the business account owns when a request for stock issuance is received from the business account, and listing the issued stock of the business account on a stock exchange within the system by using the business account activity information of the business account and social influence of the business account as evaluation bases so that the personal account is capable of trading the stock, in step S160; and
managing paying a predetermined advertising cost to the business account and to the site to which the online account of the business account belongs, on condition that an order for an advertisement is received and the advertisement is published to the business account, and managing paying a predetermined dividend to the personal account that owns the stock of the business account, according to advertising revenue of the business account, in an advertisement and dividend management step in step S170.

In addition, according to the present disclosure, the stock trading method based on activity valuation of the external online account includes providing an interface for accessing the site when an icon of the site is clicked after a site within the system is accessed through the personal account, and for being automatically linked to a personal activity log page on the site of which the icon is clicked.

In addition, as described above, in selectively collecting and managing the agreed personal information with respect to the online account on the site and the agreed personal activity information, required information is selectively collected by using an open application program interface (open API) or a data collection technology including crawling.

In addition, according to the present disclosure, in the advertisement and dividend management step of the stock trading method based on activity valuation of the external online account, the post response information with respect to the post uploaded to the business account and the personal information of the personal account that has accessed the business account are analyzed, and business account visitor information including a sex, an age, and a field of interest of a user of a mainly visiting personal account for each business account is extracted, and the advertisement is published according to the extracted business account visitor information.

In addition, according to the present disclosure, the stock trading method based on activity valuation of the external online account includes providing a virtual money exchange service in which a user of the business account or the personal account is capable of exchanging the virtual money into cash and depositing the cash into a registered bank account of the user.

In addition, as described above, in trading the issued stock of the business account by the personal account, a stock trading time is not limited, and only the virtual money is available as currency for stock trading.

In addition, according to the present disclosure, the stock trading method based on activity valuation of the external online account includes providing at least one of online shopping mall, game, and multimedia services in which the virtual money is available as currency.

In addition, according to the present disclosure, the stock trading method based on activity valuation of the external online account includes providing a virtual money bank service, wherein the virtual money bank service includes a virtual money-related financial service including load of the virtual money loan, and a service for issuing a credit card available within the stock trading system based on activity valuation of the external online account.

As described above, the stock trading system based on activity valuation of an external online account according to the present disclosure can create a new stock market through popularity evaluation of the values of activities of online accounts of individuals or groups.

In the system of the present disclosure, in principle, stock trading in the stock exchange is performed with only the virtual money mined in the system of the present disclosure, so the more encouraged the stock trading in the stock exchange, the higher the value of the virtual money mined in the system of the present disclosure.

The present disclosure have been described with reference to the embodiments shown in the accompanying drawings for illustrative purposes, and those skilled in the art to which the present disclosure pertains will easily understand that various modifications and equivalent embodiments may be made from the embodiments. Accordingly, the scope of the present disclosure should be determined by the appended claims.

### INDUSTRIAL APPLICABILITY

According to the present disclosure, an online account on another site including at least one selected from a group of a blog account, an SNS account, a web cafe account, and a multimedia streaming account is regarded as a business account and stock of the business account is issued, and the issued stock of the business account is listed on a stock exchange of the system by using a post response, such as a comment, a like mark, etc., to a post uploaded to the business account and social influence of the business account as evaluation bases, and the business account and a personal account are provided with virtual money corresponding to a post uploading activity of the business account and activities, such as a comment, a like mark, etc., of the personal account, and the virtual money is serviced to be used as stock trading currency in the stock exchange, thereby providing a new paradigm stock market system.

1. A stock trading system based on activity valuation of an external online account, the stock trading system comprising:
a business account management part configured to provide and manage an interface for joining the system with the online account on another site as a business account and for making a request for issuance of stock of the business account that has joined the system, and configured to collect and manage business account activity information including post upload information of the business account and post response information, wherein the online account includes at least one selected from a group of a blog account, an SNS account, a web cafe account, and a multimedia streaming account, and the post response information includes the number of views, a comment, a like/dislike mark, a heart mark, a thumbs-up/down mark, and a recommendation/non-recommendation mark with respect to an uploaded post;
a personal account management part configured to provide and manage an interface for opening an personal account through membership registration, and configured to provide and manage an interface for agreeing to collect personal information and personal activity information, and configured to selectively collect and manage the agreed personal information with respect to the online account on the site and the agreed personal activity information with respect to the post uploaded to the business account, and configured to provide and manage an interface for performing trade of the issued stock of the business account, wherein the personal information is capable of accessing the business account and reading the post uploaded to the business account after membership registration, with respect to the online account on the site including at least one selected from the group of the blog account, the SNS account, the web cafe account, and the multimedia streaming account, and the personal activity information includes a comment input, a like/dislike input, a heart input, a thumbs-up/down input, and a recommendation/non-recommendation input with respect to the post uploaded to the business account;
a stock exchange management part configured to provide stock information including a real-time stock price and a trading volume of the issued stock of the business account, and configured to provide and manage an interface for enabling the personal account to access the interface and trade the stock;
a virtual money mining part configured to score the business account activity information of the business account and the personal activity information of the personal account according to predetermined criteria, and provide the business account and the personal account with virtual money corresponding to scores;
a business account stock management part configured to issue the stock in response to the request for stock issuance received from the business account, and manage listing or delisting the issued stock of the business account on or from a stock exchange by using the post response information with respect to the post uploaded to the business account and social influence of the business account as evaluation bases;
an advertisement and dividend management part configured to manage paying a predetermined advertising cost to the business account and to the site to which the online, account of the business account belongs, on condition that an order for an advertisement is received and the advertisement is published to the business account, and manage paying a predetermined dividend to the personal account that owns the stock of the business account, according to advertising revenue of the business account; and
a database configured to store and manage data of the business account management part, the personal account management part, the stock exchange management part, the virtual money mining part, the business account stock management part, and the advertisement and dividend management part.

2. The stock trading system of claim 1, wherein the personal account management part is configured to provide an interface for accessing the site when an icon of the site is clicked, and for being automatically linked to a personal activity log page on the site.

3. The stock trading system of claim 1, wherein in selectively collecting and managing the agreed personal information with respect to the online account on the site and the agreed personal activity information, the personal account management part is configured to selectively collect required information by using an open application program interface (open API) or a data collection technology including crawling.

4. The stock trading system of claim 1, wherein the advertisement and dividend management part is configured to analyze the post response information with respect to the post uploaded to the business account and the personal information of the personal account that has accessed the business account, and extract business account visitor information including a sex, an age, and a field of interest of a user of a mainly visiting personal account for each business account, and publish the advertisement according to the extracted business account visitor information.

5. The stock trading system of claim 1, wherein the stock trading system based on activity valuation of the external online account further comprises
a virtual money exchange part configured to provide a virtual money exchange service in which a user of the business account or the personal account is capable of exchanging the virtual money into cash and depositing the cash into a registered bank account of the user,
wherein the virtual money exchange service is provided through an interface within the business account, the personal account, or the stock exchange, or provides a separate interface for the virtual money exchange service in the virtual money exchange part.

6. The stock trading system of claim 1, wherein in the stock exchange, a stock trading time is not limited and only the virtual money provided by the virtual money mining part is available as currency for stock trading.

7. The stock trading system of claim 1, wherein the stock trading system based on activity valuation of the external online account further comprises
a user service provision part configured to provide at least one of online shopping mall, game, and multimedia services in which the virtual money provided by the virtual money mining part is available as currency.

8. The stock trading system of claim 1, wherein the virtual money exchange part is configured to provide a virtual money bank service, wherein the virtual money bank service includes a virtual money-related financial service including loan of the virtual money, and a service for issuing a credit card available within the stock trading system based on activity valuation of the external online account.

9. A stock trading method of a stock trading system based on activity valuation of an external online account, the stock trading method comprising:
joining the system with the online account on another site including at least one selected from a group of a blog account, an SNS account, a web cafe account, and a multimedia streaming account, as a business account;
collecting and managing business account activity information that includes post upload information of the business account and post response information including the number of views, a comment, a like/dislike mark, a heart mark, a thumbs-up/down mark, and a recommendation/non-recommendation mark with respect to an uploaded post;
opening a personal account on the system through membership registration, and obtaining agreement to collect personal information and personal activity information, wherein the personal information is capable of accessing the business account and reading the post uploaded to the business account after membership registration, with respect to the online account on the site including at least one selected from the group of the blog account, the SNS account, the web cafe account, and the multimedia streaming account, and the personal activity information includes a comment input, a like/dislike input, a heart input, a thumbs-up/down input, and a recommendation/non-recommendation input with respect to the post uploaded to the business account;
selectively collecting and managing the agreed personal information with respect to the online account on the site and the agreed personal activity, information with respect to the post uploaded to the business account;
scoring the business account activity information of the business account and the personal activity information of the personal account according to predetermined criteria, and providing the business account and the personal account with virtual money corresponding to scores;
issuing stock of the business account on the basis of the virtual money that the business account owns when a request for stock issuance is received from the business account, and listing the issued stock of the business account on a stock exchange within the system by using the business account activity information of the business account and social influence of the business account as evaluation bases so that the personal account is capable of trading the stock; and
managing paying a predetermined advertising cost to the business account and to the site to which the online account of the business account belongs, on condition that an order for an advertisement is received and the advertisement is published to the business account, and managing paying a predetermined dividend to the personal account that owns the stock of the business account, according to advertising revenue of the business account, in an advertisement and dividend management step.

10. The stock trading method of claim 9, further comprising
providing an interface for accessing the site when an icon of the site is clicked after a site within the system is accessed through the personal account, and for being automatically linked to a personal activity log page on the site of which the icon is clicked.

11. The stock trading method of claim 9, wherein in selectively collecting and managing the agreed personal information with respect to the online account on the site and the agreed personal activity information, required information is selectively collected by using an open application program interface open API) or a data collection technology including crawling.

12. The stock trading method of claim 9, wherein in the advertisement and dividend management step, the post response information with respect to the post uploaded to the business account and the personal information of the personal account that has accessed the business account are analyzed, and business account visitor information including a sex, an age, and a field of interest of a user of a mainly visiting personal account for each business account is extracted, and the advertisement is published according to the extracted business account visitor information.

13. The stock trading method of claim 9, further comprising
providing a virtual money exchange service in which a user of the business account or the personal account is capable of exchanging the virtual money into cash and depositing the cash into a registered bank account of the user.

14. The stock trading method of claim 9, wherein in trading the issued stock of the business account by the personal account, a stock trading time is not limited and only the virtual money is available as currency for stock trading.

15. The stock trading method of claim 9, further comprising
providing at least one of online shopping mall, game, and multimedia services in which the virtual money is available as currency.

16. The stock trading method of claim 9, further comprising
providing a virtual money bank service,
wherein the virtual money bank service includes a virtual money-related financial service including loan of the virtual money, and a service for issuing a credit card available within the stock trading system based on activity valuation of the external online account.
